(19) United States
(12) Patent Application Publication
(10) Pub. No.: US 2015/0093153 A1
(43) Pub. Date: Apr. 2, 2015

(54) POWDER FEEDING MECHANISM, POWDER FEEDING METHOD, DEVELOPER ACCOMMODATING CONTAINER, CARTRIDGE AND IMAGE FORMING APPARATUS

(71) Applicant: CANON KABUSHIKI KAISHA, Tokyo (JP)

(72) Inventors: Hiroki Ogino, Mishima-shi (JP); Kojiro Yasui, Numazu-shi (JP)

(21) Appl. No.: 14/501,261

(22) Filed: Sep. 30, 2014

(30) Foreign Application Priority Data
Oct. 1, 2013 (JP) 2013-206714
Jul. 31, 2014 (JP) 2014-156566

(51) Int. Cl. G03G 15/08

(52) U.S. Cl. CPC G03G 15/0865
USPC 399/258

(57) ABSTRACT

A powder feeding mechanism includes: a feeding member, provided under powder, for feeding the powder; and a vibration applying member for applying reciprocating acceleration to the feeding member in a feeding surface direction along a powder feeding surface of the feeding member. Maximum acceleration applied from the vibration applying member to the feeding member in a powder feeding direction is smaller than maximum acceleration applied from the vibration applying member to the feeding member in a direction opposite to the powder feeding direction to feed the powder in the powder feeding direction by the feeding member.

### FIELD OF THE INVENTION AND RELATED ART

The present invention relates to a powder feeding mechanism, a powder feeding method, a developer accommodating container, a cartridge and an image forming apparatus.

Here, the image forming apparatus is, e.g., an electrophotographic copying machine for forming an image on a recording material (medium) by using an electrophotographic image forming type, an electrophotographic printer (such as a laser beam printer or an LED printer), a facsimile machine, or the like.

Various feeding devices for feeding powder such as a developer have been conventionally known (Japanese Laid-Open Patent Application (JP-A) 2002-196585, JP-A Sho 59-227618 and JP-A Hei 08-114985). As described in JP-A 2002-196585, a constitution in which a stirring feeding member for feeding an accommodated developer toward a developing roller while stirring the developer is provided inside a developer accommodating container detachably mountable to an inside portion of an image forming apparatus is disclosed. In this constitution, a plurality of stirring feeding members are used.

Further, as described in JP-A Sho 59-227618, a constitution of a particulate feeding device in which a particulate carrying member swingably supported and a vibration generating device for applying vibration to the carrying member are provided and in which particulates carried by the carrying member are fed by vibrating the carrying member is disclosed.

Further, as described in JP-A Hei 08-114985, a constitution in which a developer guiding plate for feeding a developer and a vibrating device for applying vibration to the developer guiding plate are provided and in which the developer on the developer guiding plate is fed by vibrating the developer guiding plate is disclosed.

However, in the constitution of JP-A 2002-196585, the stirring feeding member can feeding only the developer in a range of a radius of rotation, and therefore there is a need to constitute a bottom of the accommodating container in an arcuate shape as seen in a cross-section. Accordingly, there is a need to prevent the developer from stagnating in a region of a projected portion formed on a floor surface, of the accommodating container, where the stirring feeding member reaches the floor surface. However, this projected portion constitutes a dead space.

Further, in the constitution of JP-A Sho 59-227618, there is a need to ensure a space for permitting swing of the carrying member, and this space constitutes the dead space.

Further, in the constitution of JP-A Hei 08-114985, in order to support the developer guiding plate by a developing container, the developer guiding plate and the developing container are connected by a leaf spring member, and therefore a space in which the leaf spring member is provided constitutes the dead space.

### SUMMARY OF THE INVENTION

A principal object of the present invention is to provide a powder feeding mechanism capable of reducing a dead space of a powder feeding path compared with the conventional constitutions.

According to an aspect of the present invention, there is provided a powder feeding mechanism comprising: a feeding member, provided under powder, for feeding the powder; and a vibration applying member for applying reciprocating acceleration to the feeding member in a feeding surface direction along a powder feeding surface of the feeding member, wherein maximum acceleration applied from the vibration applying member to the feeding member in a powder feeding direction is smaller than maximum acceleration applied from the vibration applying member to the feeding member in a direction opposite to the powder feeding direction to feed the powder in the powder feeding direction by the feeding member.

According to another aspect of the present invention, there is provided a powder feeding mechanism comprising: a feeding member, provided under powder, for feeding the powder; and a vibration applying member for applying reciprocating acceleration to the feeding member in a direction perpendicular to a powder feeding surface of the feeding member to vibrate, wherein at least a part of the feeding member is fixed and a progressive wave to be generated from the vibration applying member as a source is generated in the feeding member to feed the powder in an advancing direction of the progressive wave.

According to the present invention, the dead space of the powder feeding path can be reduced compared with the conventional constitutions.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view of an image forming apparatus according to Embodiment 1.

FIG. 2 is a sectional view of a cartridge according to Embodiment 1.

In FIG. 3, (a) is a sectional view of a developer feeding mechanism according to Embodiment 1, and (b) is a waveform chart of a powder in Embodiment 1.

In FIG. 4, (a) is a sectional view of a developer feeding mechanism according to Embodiment 2, and (b) is a partly enlarged sectional view of (a) of FIG. 4.

In FIG. 5, (a) is a sectional view of a developer feeding mechanism according to Embodiment 3, (b) is a partly enlarged sectional view of (a) of FIG. 5, and (c) is a perspective view of the developer feeding mechanism.

In FIG. 6, (a) is a sectional view of a developer feeding mechanism according to a modified example of Embodiment 3, (b) is a partly enlarged sectional view of (a) of FIG. 6, and (c) is a perspective vie of the developer feeding mechanism.

In FIG. 7, (a) is a sectional view of a developer feeding mechanism according to Embodiment 4, and (b) is a waveform chart of a standing wave in Embodiment 4.

FIG. 8 is a graph showing positions of nodes of frequencies used for the developer feeding mechanism in Embodiment 4.

FIG. 9 is a sectional view of a developer feeding mechanism in a modified embodiment.

### DESCRIPTION OF THE PREFERRED EMBODIMENTS

Embodiments of the present invention will be described with reference to the drawings. However, dimensions, materials, shapes, relative arrangements of constituent elements (parts) and the like described in the following embodiments do not limit the scope of the present invention thereto unless otherwise specified. Further, in the following embodiments, materials, shapes and the like of members once described are similar to those first described unless otherwise particularly specified again.

In the following description, a longitudinal direction of a cartridge is an axial direction of an image bearing member. Further, left and right are those when a recording material is seen from above along a feeding direction (conveyance direction) of the recording material. Further, an upper surface of the cartridge is a surface positioned at an upper portion in a state in which the cartridge is mounted in an apparatus main assembly, and a lower surface of the cartridge is a surface positioned at a lower portion in the state.

### Embodiment 1

### General Structure of Image Forming Apparatus

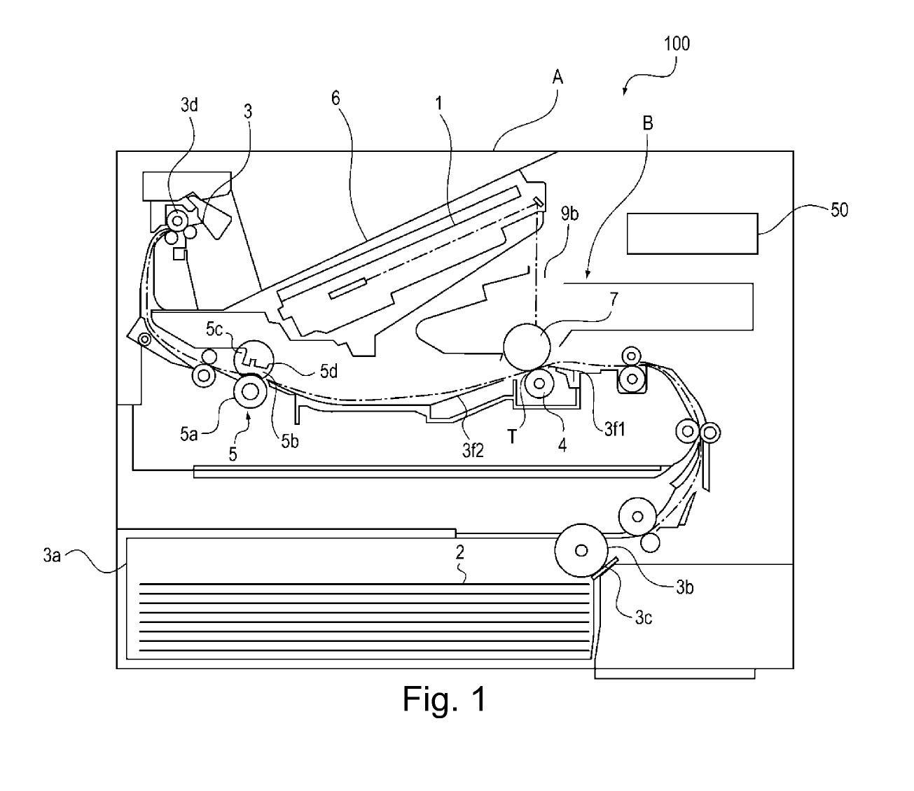

First, a general structure of an electrophotographic image forming apparatus 100 will be described with reference to FIG. 1. FIG. 1 is a schematic sectional view of the image forming apparatus 100 in which a cartridge B according to Embodiment 1 is mounted. More specifically, FIG. 1 is the schematic sectional view of a laser beam printer as an example of the image forming apparatus 100.

As shown in FIG. 1, the image forming apparatus 100 (laser beam printer) includes an apparatus main assembly A for image formation and the cartridge B detachably mountable to the apparatus main assembly A. Inside the apparatus main assembly A, a photosensitive drum 7 is provided.

Further, in the image forming apparatus 100, information light on the basis of image information is emitted from an optical system 1 as an optical means (optical device) to a drum-shaped photosensitive drum 7, so that an electrostatic latent image is formed on the photosensitive drum 7. This electrostatic latent image is developed with a developer (hereinafter referred to as a toner), so that a toner image is formed. Then, in synchronism with the formation of the toner image, a recording material (e.g., recording paper, OHP sheet, cloth or the like) 2 is separated and fed one by one from a cassette 3a by a pick-up roller 3b and a press-contact member 3c which press-contacts the pick-up roller 3b.

The fed recording material 2 is conveyed along a conveying guide 3f1 to a transfer portion T where the photosensitive drum 7 of the process cartridge B and a transfer roller 4 as a transfer means oppose each other. Onto the recording material 2 conveyed to the transfer portion T, the toner image formed on the photosensitive drum 7 is transferred by the transfer roller 4 to which a voltage is applied, and then the recording material 2 is conveyed along a conveying guide 3f2 to a fixing device 5.

The fixing device 5 includes a driving roller 5a and a rotatable fixing member 5d which incorporates a heater 5b and which is constituted by a cylindrical sheet rotatably supported by a supporting member 5c. The fixing device 5 applies heat and pressure to the recording material 2 passing through the fixing device 5, thus fixing the transferred toner image on the recording material 2.

A discharging roller 3d is constituted so that it conveys the recording material 2 on which the toner image is fixed and discharges the recording material 2 toward a discharging portion 6 via a reverse conveying path. Incidentally, in this embodiment, the pick-up roller 3b, the press-contact member 3c, the discharging roller 3d, and the like constitute a conveying device 3. Incidentally, a controller 50 controls drive of the apparatus main assembly A and internal equipment. Particularly, the controller 50 controls drive of a vibratable member 13 as a vibration applying member and a cam member 15 (described later).

### (Cartridge)

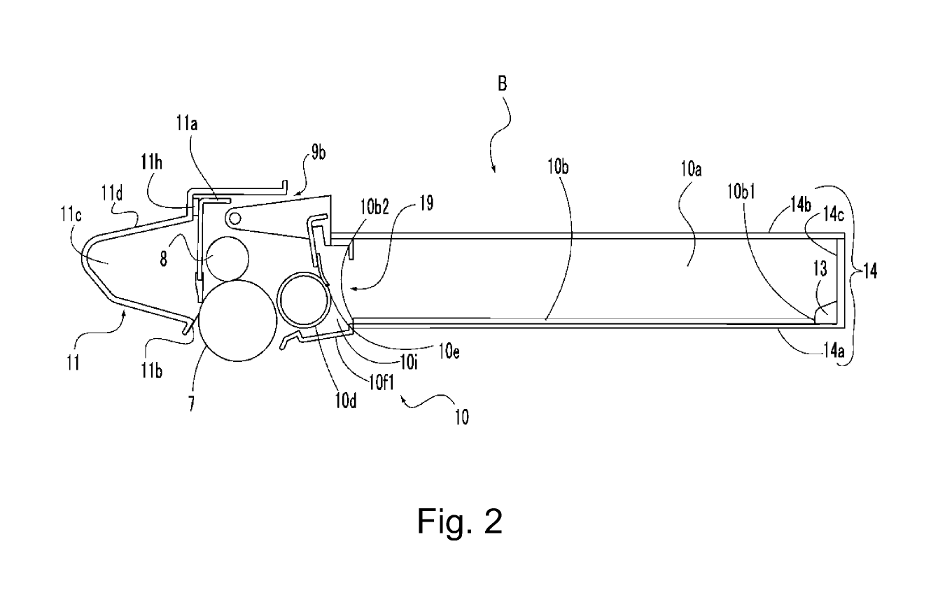

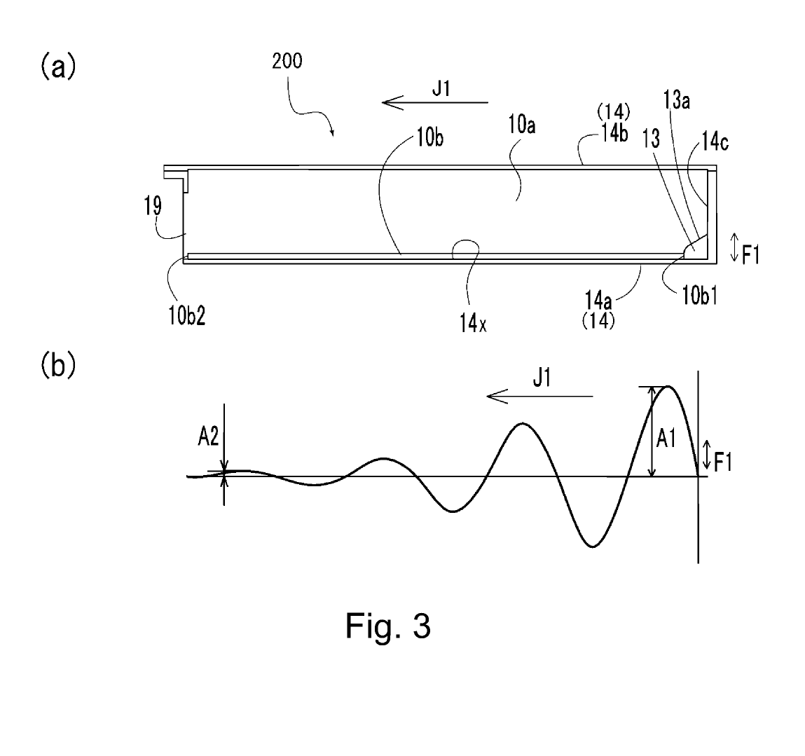

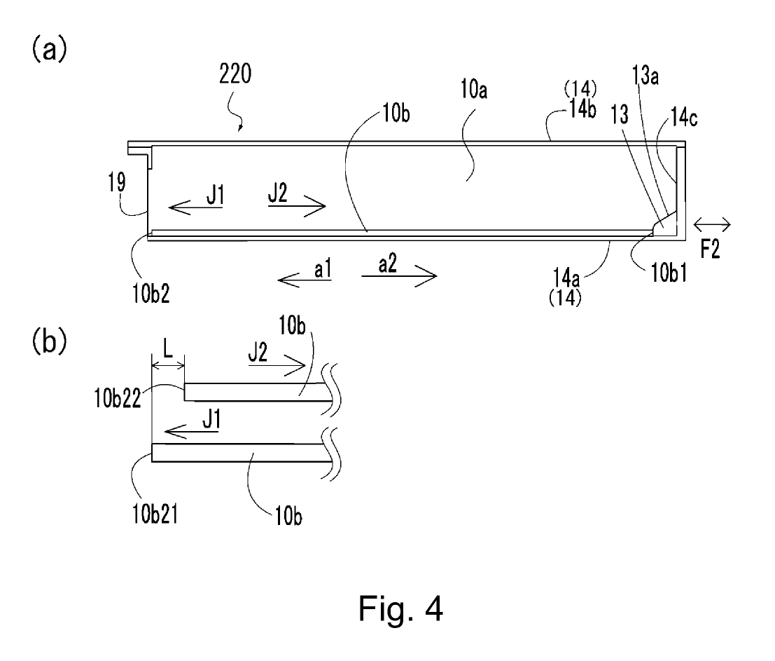

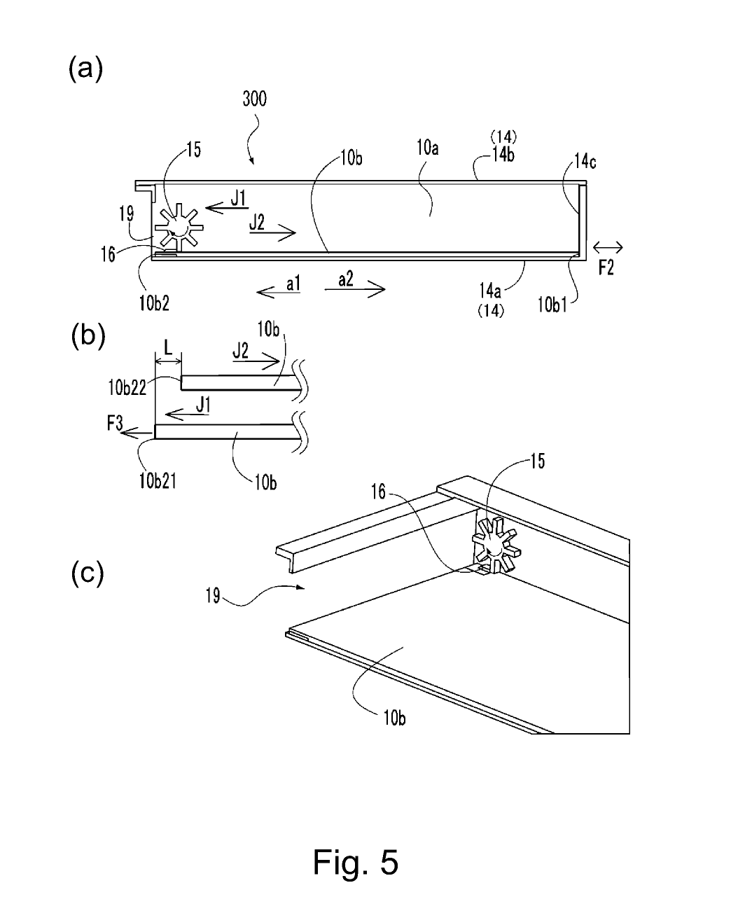

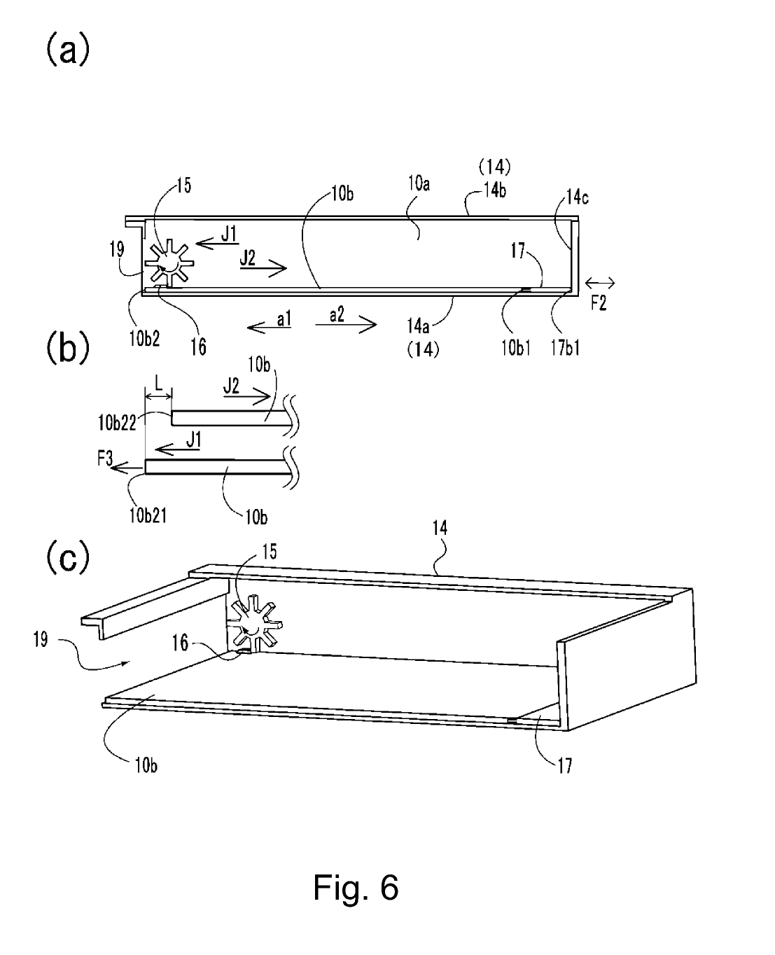

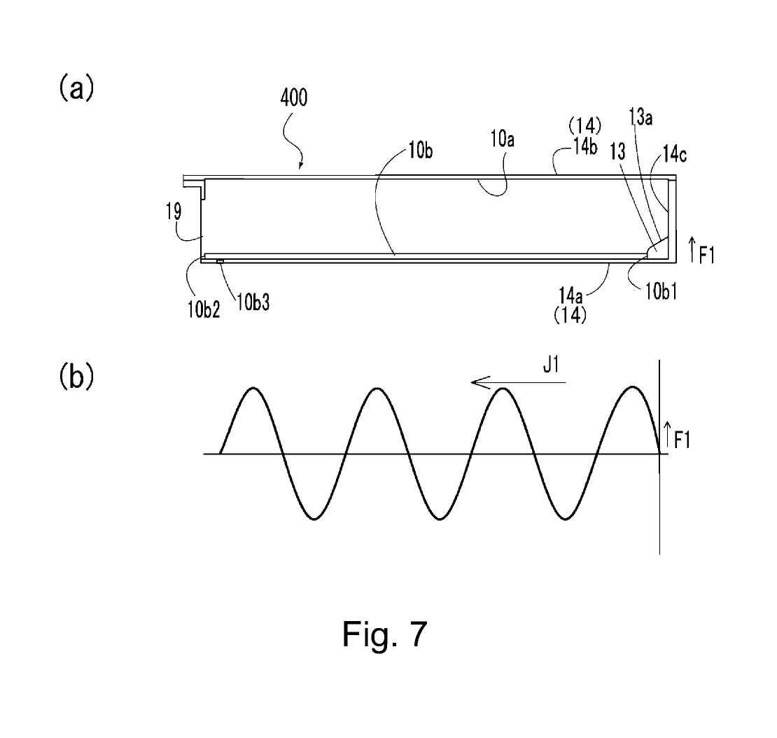

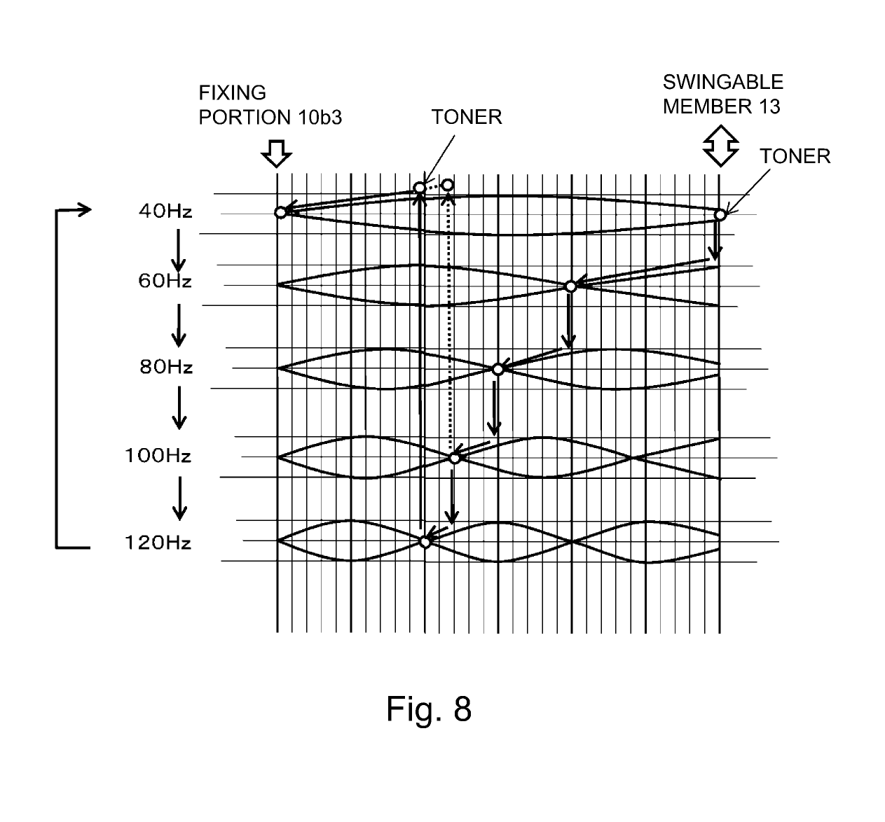

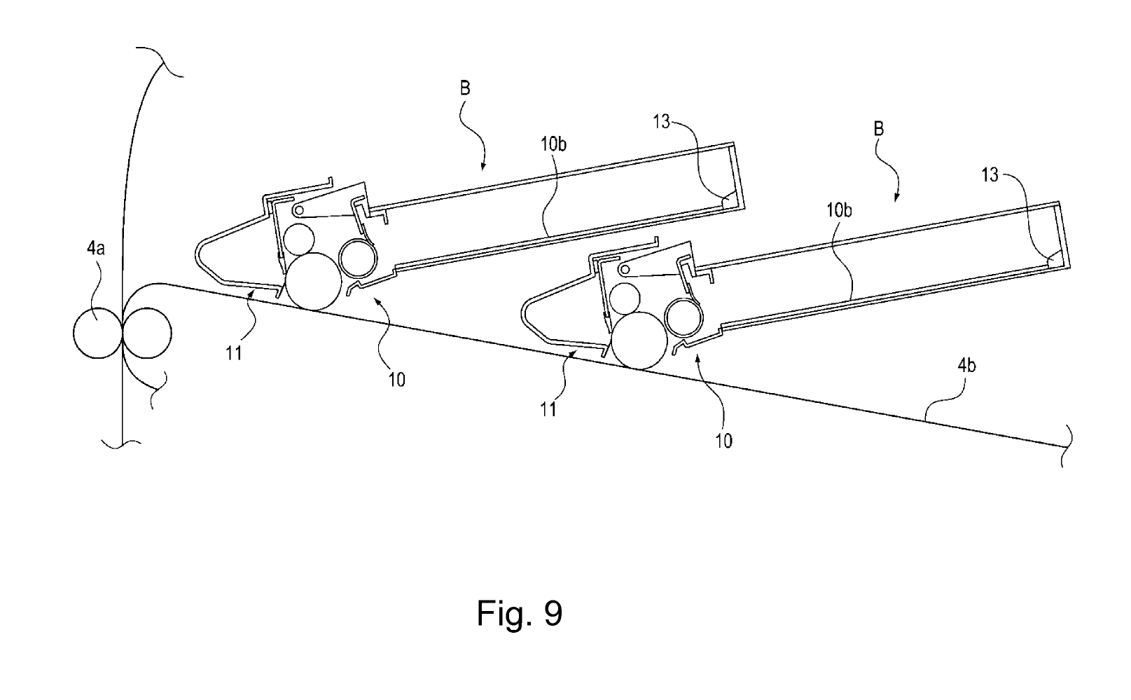

Next, the general structure of the cartridge B (process cartridge) will be schematically described with reference to FIG. 2. FIG. 2 is a schematic sectional view of the cartridge B.

As shown in FIG. 2, the cartridge B includes the photosensitive drum 7 as an image bearing member for bearing a developer image and includes at least one process means. Here, as the process means, there are, e.g., a charging means for electrically charging the photosensitive drum 7, a developing means for developing the electrostatic latent image formed on the photosensitive drum 7, a cleaning means for removing the toner remaining on the photosensitive drum 7, and the like.

In the process cartridge B, the photosensitive drum 7 provided with a photosensitive layer is rotated and a surface thereof is uniformly charged by applying a voltage to a charging roller 8 as the charging means. The charged surface of the photosensitive drum 7 is exposed, through an exposure opening 9b, to information light (light image) on the basis of image information from an optical system 1 (FIG. 1), so that the electrostatic latent image is formed on the surface of the photosensitive drum 7, and then the electrostatic latent image is to be developed by a developing unit 10. The developing unit 10 is a developing device.

The developing unit 10 includes accommodates the toner in a toner accommodating portion 10a formed by a container body 14a and a container cap member 14b of an accommodating container 14 as a developer accommodating container. A developer feeding member 10b feeds the toner, in the toner accommodating portion 10a, toward a developing chamber 10i.

Then, in the developing unit 10, a developing roller 10d as a developer carrying member for carrying the developer is rotated. With this rotation, a toner layer to which triboelectric charges are provided by a developing blade 10e is formed on a surface of the developing roller 10d, and then the toner is transferred onto the photosensitive drum 7 depending on the electrostatic latent image, so that the toner image is formed to provide a visible image.

Then, a voltage of an opposite polarity to the charge polarity of the toner image is applied to the transfer roller 4, so that the toner image is transferred onto the recording material 2. Thereafter, the toner remaining on the photosensitive drum 7 is scraped off by a cleaning blade 11a fixed to a drum frame 11d at a feeding direction 11h. At the same time, the toner is scooped by a receptor sheet 11b, so that the toner is collected in a removed toner accommodating portion 11c. A constitution in which the residual toner on the photosensitive drum 7 is removed by these cleaning means is employed.

The cartridge B includes a drum unit 11 constituted by a drum frame 11 which rotatably supports the photosensitive drum 7 and in which the cleaning blade 11a and the charging roller 8 are incorporated. Further, the cartridge B includes the developing unit 10 constituted by a developing (device) frame 10f1 in which the developing roller 10d and the toner accommodating portion 10a are incorporated. The cartridge B includes the drum unit 11 and the developing unit 10.

### 1. Toner Feeding by Progressive Wave (Mechanism 1)

### (Toner Feeding Constitution of Developer Feeding Mechanism)

Next, a toner feeding constitution of a developer feeding mechanism 200 will be specifically described with reference to FIGS. 1 to 3. Here, the developer feeding mechanism 200 includes the accommodating container 14, the feeding member 10b and the vibratable member 13.

In FIG. 3, (a) is a sectional view of the developer feeding mechanism 200, and (b) is a waveform chart of a progressive wave. As shown in FIG. 3, the developer feeding mechanism 200 as a powder feeding mechanism includes the accommodating container 14 for accommodating powder (developer in this embodiment). The accommodating container 14 includes the container body 14a and the container cap member 14b. When the container cap member 14b is mounted to the container body 14a, an opening 19 is formed. Further, when the cartridge B is mounted in the apparatus main assembly A, a floor surface 14x of the container body 14a is set so as to be substantially horizontal. Incidentally, the opening 19 is an opening for permitting supply of the toner, in the accommodating container 14, toward the developing roller 10d (FIG. 2).

Next, the feeding member 10b will be described.

The feeding member 10b is disposed under the powder, and is a plate-like member for feeding the developer. The feeding member 10b is disposed on the floor surface 14x of the accommodating container 14. The feeding member 10b is constituted so that at least a part of the feeding member 10b is fixed to the vibratable member 13, and a progressive wave to be generated from the vibratable member 13 as a (generating) source is generated in the feeding member 10b (progressive wave generating step) and the developer is fed in a feeding direction J1 as a powder feeding direction by the feeding member 10b (powder feeding step). This feeding direction J1 can also be expressed as an advancing direction of the progressive wave.

Incidentally, the developer feeding mechanism 200 is different from a constitution in which the accommodating container 14 is directly vibrated or swung, and is a constitution in which the feeding member 10b placed on the floor surface 14x of the accommodating container 14 is vibrated. This is because in the case where the accommodating container 14 is vibrated or swung, a mechanism for vibrating or swinging the accommodating container 14 is required to be provided outside the accommodating container 14 and there is a need to ensure a space therefor, and therefore the mechanism and the space are useless and thus the constitution of the above-described embodiment is employed. Further, the above constitution is employed also for avoiding a situation such that when the accommodating container 14 is directly vibrated or swung, an error or the like is generated with respect to positional accuracy of the developing roller 10d assembled with the accommodating container 14 and can adversely affect image formation.

With respect to the feeding member 10b, a free end thereof with respect to the feeding direction J1 is a free end portion 10b2, and a base end thereof with respect to the feeding direction J1 is a fixing portion 10b1. The fixing portion 10b1 is fixed to the vibratable member 13 for transmitting vibration to the feeding member 10b and constitutes a fixed end. The free end portion 10b2 is not fixed to the floor surface 14x and constitutes the free end.

Further, as a material for the feeding member 10b, a 300 μm-thick silicone rubber is used, but the material may also be not limited to this silicone rubber material. The material for the feeding member 10b may also be a general-purpose elastomer material such as acrylic rubber, natural rubber or butyl rubber. The material for the feeding member 10b may also be a general-purpose plastic material such as polyethylene terephthalate (PET), polystyrene (PS), polyethylene (PE), polypropylene (PP), ABS resin, polycarbonate (PC) or polyacetal (POM).

Next, the vibratable member 13 will be described. The vibratable member 13 applies reciprocating acceleration to the feeding member 10b in a perpendicular direction perpendicular to a developer feeding surface as a powder feeding surface to vibrate. The vibratable member 13 is disposed upstream of the feeding member 10b with respect to the feeding direction J1.

When the vibratable member 13 vibrates in the perpendicular direction F1 to the feeding member 10b, the vibration of the vibratable member 13 is transmitted to the feeding member 10b via the feeding direction 10b1, so that the feeding member 10b vibrates in the toner accommodating portion 10a. Here, a vibration frequency of 40 Hz and an amplitude of about 0.8 mm were selected. The vibratable member 13 is disposed in the neighborhood of a rear end portion 14c opposite from the opening 19 of the accommodating container 14, and at an upper portion thereof, an inclined surface portion 13a is formed.

Further, the vibratable member 13 is constituted by a member vibratable by a general-purpose vibration applying device body or vibration applying device, capable of generating vibration, such as a piezoelectric element.

Here, as shown in FIG. 3, when the vibratable member 13 vibrates, the fixing portion 10b1 of the feeding member 10b reciprocates in the perpendicular direction F1 to the feeding member 10b, so that the vibration is transmitted from the fixing portion 10b1 toward the free end portion 10b2 of the feeding member 10b. At this time, a maximum amplitude A1, generated by the vibratable member 13, in the feeding direction 10b1 side of the feeding member 10b is larger than a maximum amplitude A2 in the free end portion 10b2 side of the feeding member 10b.

This is because the amplitude of the vibration applied to the feeding member 10b is attenuated by absorption of the vibration by the feeding member 10b itself. As a result, the progressive wave in which a peak-to-valley portion of the feeding member 10b moves from the fixing portion 10b1 side toward the free end portion 10b2 side generates.

Here, of the toner positioned at an inclined surface portion of the progressive wave, there is a toner (component) which cannot remain on the inclined surface but drops into the valley portion of the progressive wave. At this time, the valley portion moves together with the progressive wave, and therefore by repeating this operation, it becomes possible to feed the toner in the same direction as a direction of the progressive wave.

Accordingly, by the progressive wave moving from the fixing portion 10b1 toward the free end portion 10b2, the toner on the feeding member 10b is fed in the direction (feeding direction) J1 directed toward the opening 19 side of the accommodating container 14.

Here, in the case of a high frequency such as a vibration period of 50 kHz, as described in Japanese Patent No. 2829938, it is well-known that the toner moves in a direction opposite to the direction of the progressive wave. However, as in this embodiment, in a low-frequency region, it would be considered that this feeding mechanism is not applied but the toner means in the direction of the progressive wave in accordance with the mechanism described above.

Further, the inclined surface portion 13a is provided at the upper portion of the vibratable member 13, and therefore the toner on the vibratable member 13 can slip on the inclined surface portion 13a by vibration of the vibratable member 13 to reach the feeding member 10b. For this reason, the inclined surface portion 13a prevents the toner from remaining on the vibratable member 13.

### Embodiment 2

### 2. Toner Feeding by Acceleration (Mechanism 2)

Here, the toner feeding constitution of the developer feeding mechanism is not limited to the constitution described above. For example, the toner feeding constitution may also be a toner feeding constitution of a developer feeding mechanism 220 shown in FIG. 4. In FIG. 4, (a) is a sectional view of the developer feeding mechanism 220, and (b) is a partly enlarged sectional view of (a) of FIG. 4. Incidentally, in Embodiment 2, constituent elements identical to those in Embodiment 1 are represented by the same reference numerals or symbols and will be omitted from description. The description in Embodiment 1 is applied to also this embodiment.

### (Toner Feeding Constitution of Developer Feeding Mechanism)

The toner feeding constitution of the developer feeding mechanism in this embodiment will be described specifically with reference to FIGS. 1, 2 and 4. Incidentally, of the constituent elements in this embodiment, those similar to those in Embodiment 1 are represented by the same reference numerals or symbols, and the description in Embodiment 1 is applied to also this embodiment and will be omitted from description in this embodiment.

As a material for the feeding member 10b, a 1 mm-thick polystyrene (PS) was used, but the material is not limited to the polystyrene material. The material for the feeding member 10b can also be appropriately constituted by a general-purpose plastic material such as polyethylene terephthalate (PET), polyethylene (PE), polypropylene (PP), ABS resin, polycarbonate (PC) or polyacetal (POM) or by a general-purpose elastomer material such as silicone rubber, acrylic rubber, natural rubber or butyl rubber.

As shown in FIG. 4, the vibratable member (vibration applying member) 13 applies reciprocating acceleration to the feeding member 10b in a feeding surface direction F2 along a developer feeding surface to vibrate. When the vibratable member 13 vibrates, the vibration of the vibratable member (vibration applying member) 13 is transmitted to the feeding member 10b via the vibratable member (vibration applying member) 13 and the fixing portion 10b1 of the feeding member 10b, so that the feeding member 10b vibrates in the toner accommodating portion 10a.

At this time, by the vibration of the vibratable member 13, the free end portion 10b2 of the feeding member 10b moves to a position 10b21 where the free end portion 10b2 moves in a feeding direction J1 to the maximum, and moves to a position 10b22 where the free end portion moves in an opposite direction J2, opposite to the feeding direction J1, to the maximum.

Here, a vibration frequency of 50 Hz of the vibratable member 13 and a movement length L, of about 0.6 mm, which is difference between the positions 10b21 and 10b22 of the free end portion 10b2 of the feeding member 10b were selected.

As shown in FIG. 4, the feeding member 10b is provided with the free end portion 10b2 as a free end in the opening 19 side of the accommodating container 14, and is provided with the fixing portion 10b1 fixed to the vibratable member (vibration applying member) 13 in the opposite side from the free end portion 10b2.

Here, when the vibratable member (vibration applying member) 13 vibrates in the feeding surface direction F2 crossing the thickness direction of the feeding member 10b, the fixing portion 10b1 of the feeding member 10b vibrates, so that the vibration is transmitted from the fixing portion 10b1 toward the free end portion 10b2 of the feeding member 10b. At this time, by the vibration of the vibratable member (vibration applying member) 13, maximum acceleration a1 in the feeding direction J1 and maximum acceleration a2 in the opposite direction J2 to the feeding direction J1 are applied to the feeding member 10b.

Here, the maximum accelerational applied from the vibratable member (vibration applying member) 13 to the feeding member 10b in the feeding direction J1 is set at a value smaller than the maximum acceleration a2 applied from the vibratable member 13 to the feeding member 10b in the opposite direction J2 to the feeding direction J1 (acceleration setting step). Further, the maximum acceleration in the opposite direction J2 to the feeding direction J1 is set at acceleration at which the slides on the feeding member 10b. By such an acceleration setting step, the toner is fed in the feeding direction J1 by the feeding member 10b (powder feeding step).

Here, by setting the acceleration so that the maximum accelerational directed in the feeding direction J1 of the feeding member 10b is smaller than the maximum acceleration a2 directed in the opposite direction J2 to the feeding direction J1, a toner slipping distance on the feeding member 10b is longer during movement in the opposite direction J2 (to the feeding direction J1) than during movement in the feeding direction J1. Further, when the feeding member 10b moves in the opposite direction J2 to the feeding direction J1, the toner slipping on the feeding member 10b moves in the feeding direction J1 on the feeding member 10b relative to the fixing portion 10b1. As a result, by repeating the vibration described above, the toner on the feeding member 10b is gradually fed in the feeding direction J1.

On the other hand, in the case where the feeding member 10b moves at the maximum acceleration a2 at which the toner does not slip on the feeding member 10b in the opposite direction J2 to the feeding direction J1, the toner is not fed. That is, in the present invention, when the feeding member 10b moves in the opposite direction J2 opposite to the feeding direction J1, the feeding member 10b is required to have the maximum acceleration such that the toner can slip on the feeding member 10b.

At this time, the slip of the toner on the vibrating feeding member 10b is not limited to slip, between the feeding member 10b and the toner, generated at an interface between the feeding member 10b and the toner, but may also include slip generated at an interface between the toner (component) and an upper toner (component) positioned on the toner. Further, the vibration applying member 13 is not limited to the constitution described above, but may also be a constitution, as shown in FIG. 5, such that vibration is applied to a contact portion 16, provided on the feeding member 10b, by a rotating cam member 15.

### Embodiment 3

### 3. Toner Feeding by Acceleration (Mechanism 2) (Rubber Feeding Member)

Here, the toner feeding constitution of the developer feeding mechanism is not limited to the constitution described above. For example, the toner feeding constitution may also be a toner feeding constitution of a developer feeding mechanism 300 shown in FIG. 5. In FIG. 5, (a) is a sectional view of the developer feeding mechanism 300 according to Embodiment 3, (b) is a partly enlarged sectional view of (a) of FIG. 5 and (c) is a perspective view of the developer feeding mechanism 300. Incidentally, of constituent elements in Embodiment 3, those identical to those in Embodiments 1 and 2 are represented by the same reference numerals or symbols and will be omitted from description. The description in each of Embodiments 1 and 2 is applied to also this embodiment.

### (Toner Feeding Constitution of Developer Feeding Mechanism)

The toner feeding constitution of the developer feeding mechanism 300 in this embodiment will be described specifically with reference to FIGS. 1, 2 and 5. Here, the developer feeding mechanism 300 includes the accommodating container 14 and the feeding member 10b.

Further, as a material for the feeding member 10b, a 0.3 mm-thick silicone rubber was used, but the material is not limited to the silicone rubber. The material for the feeding member 10b can also be appropriately constituted by a general-purpose elastomer material such as acrylic rubber, natural rubber or butyl rubber.

As shown in FIG. 5, the feeding member 10b in the toner accommodating portion 10a is fixed to the accommodating container 14 at the fixing portion 10b1. In this way, the feeding member 10b may only be required to be fixed at least one position.

As shown in FIG. 5, an operation in which the free end portion 10b2 of the feeding member 10b is pulled in the feeding direction J1 by a force F3 and then the pulling is eliminated is performed periodically.

In this embodiment, the feeding member 10b is provided with the contact portion 16 for accelerating reciprocating motion of the feeding member 10b in the feeding surface direction F2 crossing the thickness direction of the feeding member 10b in the accommodating container 14. Further, in the accommodating container 14, a rotatable cam member 15 as a vibratable member (vibration applying member) is disposed so as to oppose the contact portion 16 provided on the feeding member 10b.

The cam member 15 applies reciprocating acceleration to the feeding member 10b via the contact portion 16 in the feeding surface direction F2 along the developer feeding surface to expand and contract the feeding member 10b. As a result, the vibration for reciprocating the feeding member 10b in the feeding surface direction is applied.

The case where the contact portion 16 capable of reciprocating in the feeding surface direction F2 crossing the thickness direction of the feeding member 10b is moved in the accommodating container 14 by the cam member 15 is described as an example, but the contact portion 16 may also be moved by a vibration applying device (vibration applying member) such as a piezoelectric element.

As a result, the feeding member 10b constituted by the silicone rubber which is a high elastic member repeats expansion and contraction, thus vibrating in the feeding surface direction F2 crossing the thickness direction of the feeding member 10b in the toner accommodating portion 10a.

At this time, by the vibration of the vibratable member 13, the free end portion 10b2 of the feeding member 10b moves to a position 10b21 where the free end portion 10b2 moves in a feeding direction J1 to the maximum, and moves to a position 10b22 where the free end portion moves in an opposite direction J2, opposite to the feeding direction J1, to the maximum.

Here, a vibration frequency of 50 Hz of the force F3 applied to the free end portion 10b2 of the feeding member 10b and a movement length L, of about 0.6 mm, which is difference between the positions 10b21 and 10b22 of the free end portion 10b2 of the feeding member 10b were selected. Further, an elastic force, of the feeding member 10b, of about 200 gf/mm and a toner weight of about 100 g were selected.

The feeding member 10b vibrates by periodically performing the operation in which the free end portion 10b2 of the feeding member 10b is pulled in the feeding direction J1 by the force F2 and then the pulling is eliminated. By this vibration, maximum accelerational in the feeding direction J1 and maximum acceleration a2 in the opposite direction J2 to the feeding direction J1 are applied to the feeding member 10b.

Here, the maximum acceleration a1 applied from the cam member 15 to the feeding member 10b in the feeding direction J1 is set at a value smaller than the maximum acceleration a2 applied from the cam member 15 to the feeding member 10b in the opposite direction J2 to the feeding direction J1 by adjusting the number of rotation of the cam member 15 (acceleration setting step). By such an acceleration setting step, the developer is fed in the feeding direction J1 by the feeding member 10b (powder feeding step).

Here, by setting the acceleration so that the maximum acceleration a1 in the feeding direction J1 of the feeding member 10b is smaller than the maximum acceleration a2 in the opposite direction J2, a toner slipping distance on the feeding member 10b is longer during movement in the opposite direction J2 than during movement in the feeding direction J1. Further, when the feeding member 10b moves in the opposite direction J2 to the feeding direction J1, the toner slipping on the feeding member 10b moves in the feeding direction J1 on the feeding member 10b relative to the fixing portion 10b1. As a result, by repeating the vibration described above, the toner on the feeding member 10b is gradually fed in the feeding direction J1.

On the other hand, in the case where the feeding member 10b moves at the maximum acceleration a2 at which the toner does not slip on the feeding member 10b in the opposite direction J2 to the feeding direction J1, the toner is not fed. That is, in the present invention, when the feeding member 10b moves in the opposite direction J2 opposite to the feeding direction J1, the feeding member 10b is required to have the maximum acceleration such that the toner can slip on the feeding member 10b.

At this time, the slip of the toner on the vibrating feeding member 10b is not limited to slip, between the feeding member 10b and the toner, generated at an interface between the feeding member 10b and the toner, but may also include slip generated at an interface between the toner (component) and an upper toner (component) positioned on the toner. Further, the vibration applying member 13 is not limited to the constitution described above, but may also be a constitution, as shown in FIG. 5, such that vibration is applied to a contact portion 16, provided on the feeding member 10b, by a rotating cam member 15.

FIG. 6 includes schematic views of a developer feeding mechanism in which the feeding member 10b is connected with an elastic member 17. In FIG. 6, (a) is a sectional view of the developer feeding mechanism, (b) is a partly enlarged view of (a) of FIG. 6, and (c) is a perspective view of the developer feeding mechanism. Incidentally, in this modified example, it can be defined that the feeding member 10b and the elastic member 17 constitute the feeding member.

The feeding member 10b is formed of the general-purpose plastic material. The elastic member 17 is formed of the general-purpose elastomer material. Further elastic member 17 is connected with the fixing portion 10b1 of the feeding member 10b in a left side, and is connected with a rear end portion 14b of the accommodating container 14 in a right side.

Here, the case where the feeding member 10b is moved by the cam member 15 is illustrated, but the feeding member 10b may also be moved by the vibration applying device such as the piezoelectric element.

As described above, in Embodiment 3, it can be said that all or a part of the feeding member 10b is formed with the elastic member 17. Further, in this embodiment, the elastic member 17 may be the elastomer, but may also use another member, showing elasticity, such as a spring. Here, the above-described elastic member 17 is essential to the case where the elastic member 17 is constituted as the vibration applying member 10b which applies the force only in one direction, but is not essential to the case where the elastic member 17 is constituted as the vibration applying member 10b capable of generating a reciprocating force in the feeding surface direction F2.

### Embodiment 4

### 4. Toner Feeding by Wavelength Change of Standing Wave (Mechanism 2)

Here, the toner feeding constitution of the developer feeding mechanism is not limited to the constitution described above. For example, the toner feeding constitution may also be a toner feeding constitution of a developer feeding mechanism 400 shown in FIG. 7. In FIG. 7, (a) is a sectional view of the developer feeding mechanism 400 according to Embodiment 4, and (b) is a waveform chart of a standing wave. FIG. 8 is a schematic view showing a waveform chart and a state of movement of the developer. Of constituent elements in Embodiment 4, those identical to those in Embodiments 1 to 3 are represented by the same reference numerals or symbols and will be omitted from description. The description in each of Embodiments 1 to 3 is applied to also this embodiment.

### (Toner Feeding Constitution of Developer Feeding Mechanism)

The toner feeding constitution of the developer feeding mechanism 300 in this embodiment will be described specifically with reference to FIGS. 1, 2, 7 and 8. Here, the developer feeding mechanism 400 includes the accommodating container 14, the feeding member 10b and the vibratable member 13.

Further, as a material for the feeding member 10b, a 300 μm-thick silicone rubber was used, but the material is not limited to the silicone rubber.

The material for the feeding member 10b can also be appropriately constituted by a general-purpose elastomer material such as acrylic rubber, natural rubber or butyl rubber. The material for the feeding member 10b may also be a general-purpose plastic material such as polyethylene terephthalate (PET), polystyrene (PS), polyethylene (PE), polypropylene (PP), ABS resin, polycarbonate (PC) or polyacetal (POM).

As shown in FIG. 7, the feeding member 10b of the toner accommodating portion 10a is connected with the vibratable member 13 for transmitting vibration to the feeding member 10b at the fixing portion 10b1, and is fixed to the container body 14a at the fixing portion 10b3 in the free end portion 10b2 side.

As shown in FIG. 7, the vibratable member 13 applies reciprocating acceleration to the feeding member 10b in the perpendicular direction F1 perpendicular to the developer feeding surface to vibrate. A standing wave to be generated from the vibratable member 13 as a (generating) source is generated in the feeding member 10b (standing wave generating step). Then, the frequency of the standing wave is increased (frequency increasing step). As a result, the developer is fed in the feeding direction J1 by the feeding member 10b (powder feeding method). The frequency of the vibratable member 13 may be of a type in which the frequency increases continuously or a type in which the frequency increases stepwisely. However, first, the case where the frequency increases continuously will be described.

The vibration by the vibratable member 13 is transmitted to the feeding member 10b via the feeding direction 10b1, so that the feeding member 10b vibrates in the toner accommodating portion 10a. Here, a vibration frequency ranging from 40 Hz to 120 Hz and an amplitude of about 0.8 mm were selected.

Here, as shown in FIGS. 7 and 8, when the vibratable member 13 is vibrated at 40 Hz, the fixing portion 10b1 of the feeding member 10b reciprocates in the perpendicular direction F1 to the feeding member 10b, so that the vibration is transmitted from the fixing portion 10b1 toward the free end portion 10b2 of the feeding member 10b. At this time, the free end portion 10b2 is fixed by the fixing portion 10b3, so that reflected wave of the vibration generates. As a result, in the feeding member 10b, the standing wave consisting of a combined wave of the progressive wave with the reflected wave is formed.

Here, as shown in FIG. 8, the toner on the feeding member 10b gathers at a region (nodes) where the standing wave generated on the feeding member 10b little vibrates. From this state, when the frequency is gradually increased continuously to 120 Hz, the wavelength of the standing wave is gradually shortened. This shortening of the wavelength of the standing wave means that the region (nodes) where the standing wave little vibrates moves from the fixing portion 10b1 toward the free end portion 10b2 in accordance with contraction of the wavelength. Accordingly, also the toner gathering at the region (nodes) where the standing wave little vibrates moves.

In this way, in the case where the frequency is increased continuously, the frequency may only be required to be increased so that the toner gathering at the nodes is moved in the feeding direction J1 with the movement of the region (nodes), where the standing wave little vibrates, in the feeding direction J1.

Here, the frequency is not increased continuously, but may also be increased stepwisely in the order of 40 Hz, 60 Hz, 80 Hz, 100 Hz and 120 Hz with an increment of 20 Hz. In this way, in the case where the frequency is increased stepwisely, the frequency may only be required to be increased to a next-stage frequency after a lapse of a predetermined time from the movement of the toner to the region (nodes) where the standing wave little vibrates.

Then, the increase of the frequency up to 120 Hz is once stopped, and the frequency is returned to 40 Hz and then is increased again. Particularly, it is preferable, in the case where the feeding of the powder is considered, that the frequency is increased continuously or stepwisely up to 120 Hz and thereafter is abruptly decreased to 40 Hz, and then is increased again up to 120 Hz. By repeating this increase and decrease of the frequency, the powder can be fed further efficiently. Further, before the toner moved to the node in the feeding direction J1 when the frequency is 120 Hz is moved to an antinode positioned with respect to the opposite direction J2 to the feeding direction J1, the frequency is decreased continuously or stepwisely from 120 Hz to 40 Hz, and then is increased again.

By repeating this operation, it becomes possible to feed the toner from the fixing portion 10b1 toward the free end portion 10b2.

That is, this is because the toner moved to the node of 120 Hz is positioned downstream of a region (antinode), with respect to the develop J1, where an amplitude of the standing wave formed at the frequency of 40 Hz becomes maximum, and therefore the toner is fed toward a downstream node with respect to the feeding direction J1.

At this time, a maximum of the frequency of the vibratable member 13 may only be required to be set at a value larger than twice a minimum of the frequency of the vibratable member 13. This is because, as shown in FIG. 8, the node of the frequency of 80 Hz which is twice the frequency of 40 Hz is positioned at the antinode of 40 Hz, and therefore at least a half of the toner is moved to the downstream node with respect to the feeding direction J1.

Here, in general, when the developer is placed on a vibrating plate, it is well-known that the developer is flicked away in the region (antinode) where the standing wave largely vibrates and gathers at the region (node) where the standing wave little vibrates. In this embodiment, the standing wave is formed on the feeding member 10b, and the frequency of the standing wave is increased continuously, whereby the region (node) where the standing wave little vibrates was moved. As a result, the toner on the feeding member 10b is fed from the fixing portion 10b1 toward the free end portion 10b2.

Further, the inclined surface portion 13a is provided at the upper portion of the vibratable member 13, and therefore the toner on the vibratable member 13 can slip on the inclined surface portion 13a by vibration of the vibratable member 13 to reach the feeding member 10b. For this reason, the inclined surface portion 13a prevents the toner from remaining on the vibratable member 13.

According to the constitution of any one of Embodiments 1 to 4, the dead space inside the toner accommodating portion 10a is reduced, so that the developer feeding performance inside the toner accommodating portion 10a is improved. That is, by feeding the toner, in the accommodating container 14 extending in the horizontal direction, to the opening 19 by the feeding member 10b, it is possible to stably supply the toner to the developing roller 10d.

Further, in Embodiments 1 to 4, the case where the container body 14a of the accommodating container 14 has the bottom (surface) 14a1 which is substantially horizontal when the accommodating container 14 is mounted in the image forming apparatus 100 is illustrated, but there is no need to limit the present invention thereto. For example, the present invention can be suitably applied to also the case where the bottom 14a1 of the container body 14a of the accommodating container 14 is inclined with respect to the horizontal surface.

Further, in Embodiments 1 to 4, the constitution in which the cartridge B was used for forming a single-color image was employed. However, a cartridge in which a plurality of developing means (developing devices) are provided and a plurality of color images (e.g., two color images, three color images or full-color images) are formed may also be used. Further, as shown in FIG. 9, an image forming apparatus including a plurality of cartridges may also be used. In this case, a constitution such that the developer image is transferred from the photosensitive drum onto an intermediary transfer member 4b such as a transfer belt, and the transferred developer image is moved to the secondary transfer position and then is transferred onto the recording material such as paper by the secondary transfer roller 4a as the transfer means may also be employed.

Further, in Embodiments 1 to 4, the toner feeding embodiment was described, but the present invention is also applicable to toner feeding in a cleaner unit in which the transfer residual toner is collected, and toner feeding in not only the cartridge B but also the developing device and the toner cartridge.

Further, an object to be fed is not limited to the toner, but the present invention is also applicable to another powder such as powdery medicine, wheat or salt.

Incidentally, in Embodiments 1, 2 and 4, the vibratable member (vibration applying member) 13 is disposed inside the toner accommodating portion 10a, but the present invention is not limited thereto. For example, the vibratable member 13 may also be disposed outside the toner accommodating portion 10a and may be connected with the feeding member 10b to transmit the vibration.

Further, in the embodiments described above, the feeding member 10b is fixed to the container body 14a in the free end portion 10b2 side by the fixing portion 10b3, but the present invention is not limited thereto. For example, a constitution in which the feeding member 10b is not fixed in the free end portion 10b2 side and in which a degree of attenuation of the feeding member 10b is decreased by changing the material or the shape is employed, so that the present invention can be suitably applied to also the case where the standing wave is formed on the feeding member 10b by the vibration transmitted from the vibratable member (vibration applying member) 13.

Further, the frequency at which the vibratable member (vibration applying member) 13 vibrates is 5-100 Hz. Further, with respect to an inclination angle of the feeding member 10b, the developer is feedable to the opening 19 even when an ascending angle is less than 10 degrees, and is feedable to the opening 19 even when a descending angle is 60 degrees or less.

Incidentally, an embodiment in which the feeding member 10b and the vibratable member 13 are fixed to each other at least at one position, and an embodiment in which the feeding member 10b and the cam member 15 as the vibratable member are fixed to each other at least at one position may also be employed.

Further, in the above-described embodiments, the accommodating container 14 is illustrated as the developer accommodating container, but the present invention is not limited thereto. For example, the present invention is suitably applicable to also the case where the developer accommodating container is constituted, as a residual (waste) toner accommodating container for accommodating the residual toner, so as to feed the residual toner.

The constitutions of Embodiments 1 to 4 can be constituted by being appropriately combined. For example, in Embodiment 1, the constitution in which the vibratable member 13 applied the reciprocating acceleration to the feeding member 10b in the perpendicular direction F1 perpendicular to the developer feeding surface was employed. However, in contrast thereto, it is also possible to apply the constitution by modifying a structure of the contact portion 16 provided on, in place of the vibratable member 13, the cam member 15 or the feeding member 10b in Embodiment 3 (FIG. 5). For example, it is also possible to employ a constitution in which the reciprocating acceleration is applied to the feeding member 10b by the cam member 15 and the feeding member 10b in the perpendicular direction F1 perpendicular to the developer feeding surface.

Further, in Embodiment 1, the description such that the elastic member was inclined in the feeding member 10b was not made. However, in contrast thereto, in place of the feeding member 10b in Embodiment 1, it is also possible to apply a constitution in which the elastic member 17 is included in the feeding member in Embodiment 3 (FIG. 6).

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 206714/2013 filed Oct. 1, 2013 and 156566/2014 filed Jul. 31, 2014, which are hereby incorporated by reference.

What is claimed is:

1. A powder feeding mechanism comprising:
a feeding member, provided under powder, for feeding the powder; and
a vibration applying member for applying reciprocating acceleration to said feeding member in a feeding surface direction along a powder feeding surface of said feeding member,
wherein maximum acceleration applied from said vibration applying member to said feeding member in a powder feeding direction is smaller than maximum acceleration applied from said vibration applying member to said feeding member in a direction opposite to the powder feeding direction to feed the powder in the powder feeding direction by said feeding member.

2. A powder feeding mechanism comprising:
a feeding member, provided under powder, for feeding the powder; and
a vibration applying member for applying reciprocating acceleration to said feeding member in a direction perpendicular to a powder feeding surface of said feeding member to vibrate,
wherein at least a part of said feeding member is fixed and a progressive wave to be generated from said vibration applying member as a source is generated in said feeding member to feed the powder in an advancing direction of the progressive wave.

3. A powder feeding mechanism according to claim 1, wherein said vibration applying member is a vibratable member or a rotatable cam member.

4. A powder feeding mechanism according to claim 1, wherein a part or all of said feeding member is formed with an elastic member.

5. A powder feeding mechanism according to claim 4, wherein said feeding member and said vibration applying member are fixed or contacted to each other at least at one position, and
wherein said vibration applying member is provided at a position upstream of said feeding member with respect to the powder feeding direction or at a position in a downstream side of said feeding member with respect to the powder feeding direction.

6. A powder feeding mechanism according to claim 1, further comprising an accommodating container for accommodating powder,
wherein said feeding member is disposed on a floor surface of said accommodating container.

7. A powder feeding mechanism according to claim 1, wherein said vibration applying member vibrates at a frequency of 5-100 Hz.

8. A powder feeding mechanism according to claim 1, wherein an inclination angle of said feeding member is less than 10 degrees with respect to an ascending angle and is 60 degrees or less with respect to a descending angle.

9. A powder feeding mechanism according to claim 1, wherein said feeding member is formed in a plate shape.

10. A powder feeding method comprising:
an acceleration setting step of setting acceleration so that maximum acceleration applied from a vibration applying member, to which at least a part of a feeding member provided under powder for feeding the powder is fixed, to the feeding member with respect to a powder feeding direction is set at a value smaller than maximum acceleration applied from the vibration applying member to the feeding member with respect to the powder feeding direction when the vibration applying member for applying reciprocating acceleration to the feeding member in a feeding surface direction along a powder feeding surface of the feeding member vibrates; and
a powder feeding state of feeding the powder in the powder feeding direction by said acceleration setting state.

11. A powder feeding method comprising:
an acceleration setting step of setting acceleration so that maximum acceleration applied from a vibration applying member, for applying vibration to a feeding member which is provided under powder for feeding the powder and which is partly formed with an elastic member, to the feeding member with respect to a powder feeding direction is set at a value smaller than maximum acceleration applied from the vibration applying member to the feeding member with respect to the powder feeding direction by expanding and contracting the feeding member by the vibration applying member when the vibration applying member for applying reciprocating acceleration to the feeding member in a feeding surface direction along a powder feeding surface of the feeding member vibrates; and
a powder feeding state of feeding the powder in the powder feeding direction by said acceleration setting state.

12. A powder feeding method comprising:
a progressive wave generating step of generating a progressive wave, in a feeding member provided under powder for feeding the powder, to be generated from a vibration applying member, as a source and to which at least a part of the feeding member is fixed when the vibration applying member for applying reciprocating acceleration to the feeding member in a direction perpendicular to a powder feeding surface of the feeding member vibrates; and
a powder feeding state of feeding the powder in an advancing direction of the progressive wave by said progressive wave generating state.

13. A developer accommodating container comprising:
a powder feeding mechanism according to claim 1,
wherein the powder is a developer.

14. A cartridge comprising:
a powder feeding mechanism according to claim 1; and
a developer carrying member for carrying a developer.

15. A cartridge comprising:
a powder feeding mechanism according to claim 1;
an image bearing member for bearing a developer image; and
a developer carrying member for carrying a developer.

16. An image forming apparatus comprising:
a main assembly for image formation; and
a powder feeding mechanism according to claim 1,
wherein said powder feeding mechanism is detachably mountable to said main assembly.
